(19) United States
(12) Patent Application Publication
(10) Pub. No.: US 2017/0101697 A1
(43) Pub. Date: Apr. 13, 2017

(54) MAGNETIC WIRE HEAT TREATMENT APPARATUS AND MAGNETIC WIRE HEAT TREATMENT METHOD

(71) Applicant: MAGNEDESIGN CORPORATION, Chita-gun (JP)

(72) Inventor: Yoshinobu HONKURA, Chita-gun (JP)

(73) Assignee: MAGNEDESIGN CORPORATION, Chita-gun (JP)

(21) Appl. No.: 15/289,334

(22) Filed: Oct. 10, 2016

(30) Foreign Application Priority Data
Oct. 11, 2015 (JP) 2015-201632

(51) Int. Cl. C21D 9/52; H01F 41/00; C21D 9/56

(52) U.S. Cl. CPC C21D 9/525; C21D 9/564; H01F 41/00

(57) ABSTRACT

A tension annealing treatment consisting of a furnace and the operation method can improve magnetic properties of magnetic wire with a diameter of under 20 μm and achieve continuous operation without wire breakage by controlling the temperature and tensile stress in the furnace with designated values accurately by means of a wire diameter measuring device, tension measuring device, plural capstans and tension rollers between plural capstans installed in the furnace. The interval between a wire supply bobbin and a wire winding up bobbin is divided into serval parts which are controlled to have same conveyance speed and tensile stress to dissolve the deference of each other by controlling the rotary speed of capstans and the tension loaded by tension rollers.

### PRIORITY

The present application is related to, and claims the priority benefit of, Japanese patent application serial no. 2015-201632, filed Oct. 11, 2015, the contents of which are incorporated herein by reference in their entirety.

### BACKGROUND OF THE INVENTION

Technical Field

The present invention relates to tension annealing treatment to improve the magnetic property of a magnetic wire by controlling the wire temperature and tensile stress to designated values.

Background Art

FG sensor, MI sensor and GSR sensor are known as super sensitive micro sensors. Recently GSR sensor has been developed based on the discovery on the ultra-high speed rotation effect (GSR effect) excited by GHz pulse current. It uses a soft magnetic amorphous wire with the diameter of under 30 μm. In the future, it is expected to be widely used for electronics compasses, medical devices, security sensors and so on. The minute magnetic field detection performance of the GSR sensor has a magnetic performance sensitive to a minute magnetic field which is dependent on a spin structure with the circular aliment on the magnetic wire surface, the anisotropy field Hk and the hysteresis characteristics of the magnetic wire. The performance is improved by making the anisotropy field Hk and the hysteresis smaller by means of tension annealing treatment. However, the treatment is so sensitive to the temperature and tensile stress that the magnetic properties of the wire tend to become instable. Therefore, an invention which can control the temperature and tensile stress of the tension annealing treatment accurately has been desired.

The tension annealing treatment is applied to the amorphous wire produced by a rapid solidification process for improving the magnetic properties of the wire. The treatment temperature depends on the composition of the amorphous alloy. The anisotropy field becomes the smallest usually from 450° C. (degrees Celsius) to 550° C. (degrees Celsius). Higher temperature within a suitable temperature range is desirable to decrease the anisotropy field and to increase the productivity at a higher production line speed. But raising the temperature has a risk to exceed the critical temperature which causes crystallization above amorphous crystallization temperature. The anisotropy field becomes larger beyond around 550° C. On the other hand, the more tensile stress makes the less hysteresis and the more anisotropy field under the elastic limit. The desirable ranges of the temperature and the tensile stress at around 550° C. are critical targets because of the tradeoff relationship between the temperature and the tensile stress.

Patent Literature 1 discloses a thermal treatment method and an apparatus to make the circular spin aliment on the surface of amorphous magnetic wire. The thermal treatment is related to an electrical heating treatment to the magnetic wire used as a core of a rectangular flux gate sensor. The thermal treatment is done by passing direct or alternating electric current to magnetic wire. The treatment cannot keep a designated temperature constantly because the contact resistance changes irregularly. The treatment cannot be applied to the glass coated amorphous wire.

Non Patent Literature 1 discloses the detail of the tension annealing treatment method and the apparatus. In this apparatus, the wire is taken out from a wire bobbin through a wire reel and conveyed to a furnace to receive wire heat treatment and then is rolled up in a bobbin using a tension roller and a rolling up device with speed regulator called as a capstan.

When the above apparatus is used with a wire with the length of more than 1 km, the variation of ±10% in the wire diameter causes a significant change in the tensile stress even if the tension is kept constant. Even if the wire diameter, winding speed and wire tension are kept constant, the tensile stress of the wire in the furnace changes to become bigger according to the elongation of the wire caused by heating. This tension annealing treatment impairs the magnetic properties in the anisotropy field or hysteresis because the wire tensile stress increases by large diameter variation of the wire or the wire elongation by heating in the furnace. Furthermore, the variation of the tensile stress of the wire with the smaller diameter makes larger and is apt to cause breakage.

The above-mentioned prior literatures are the following:

### PRIOR LITERATURES

### Patent Literature

Patent Literature 1: Japanese Unexamined Application Publication 2015-115551

### Non-Patent Literature

Non Patent Literature 1: S. Ueno, “Cold drawn and tension annealed amorphous wire”, 99 NAGOYA International Workshop on AMORPHOUSWIRES, FILMS and MICRO MAGNETIC SENSORS.

### BRIEF SUMMARY OF INVENTION

### Technical Problem

The tension annealing furnaces applied to more than 1 km of a magnetic wire described in Patent Literature 1 and Non Patent Literature 1 have met difficulty in controlling the heat treatment temperature and keeping a constant tensile stress in the furnace respectively because of the variation of the wire diameter and the change of the wire mechanical properties resulting in wire elongation in the furnace.

The problem to be solved by the present invention is to provide a tension annealing furnace and its method to realize excellent magnetic properties of the wire stably by means of keeping the temperature and tensile stress to designated values even if there are the variations of wire diameter and change of the mechanical properties of the wire in the furnace. At the same time, they can enhance the productivity by achieving long time continuous production at a fast conveyance speed.

However, the smaller wire diameter, the longer wire wound around a wire bobbin, the longer distance between a supply bobbin and a winding up bobbin, and the faster conveyance speed cause more variations in friction at the contact with wire and wire reels and in rotation speeds of the reels and capstans. Those variations break wire more frequently and make continuous production more difficult. It means that continuous production for a long time and at a fast conveyance speed is a difficult goal to achieve.

The furnace with a longer length shows advantages in holding the wire at the designated temperature and in achieving good productivity to operate at a faster conveyance speed but disadvantage in increasing the change of the tensile stress from the designated value. The furnace with a shorter length shows advantages in keeping the wire tensile stress at the designated value but disadvantages in poor productivity to operate with a lower conveyance speed for getting the designated temperature. The above discussion teaches there are the tradeoff relationships among the furnace length, achievements in good magnetic properties, keeping at the designated value on temperature and tensile stress and the productivity. It means it is difficult to solve the problems which a tension annealing furnace and its method have met with.

In the case that amorphous wire is used as magnetic wire, the problem becomes more difficult to solve because the amorphous wire has a critical temperature which is dependent on the chemical composition to cause crystallization from amorphous structure. In the present invention, the applied wire has a critical temperature of 550 degrees C. The desirable designated temperature is a little below crystallization temperature of 550 degrees C. to make high permeability μ or low anisotropy field Hk (Oe). In the case of over crystallization temperature of 550 degrees C. the anisotropy field increases dramatically. Therefore, when amorphous wire is used, precise control of the temperature and tensile stress under the critical temperature is needed for getting the suitable magnetic property. Especially an amorphous wire with a diameter of less than 10 μm is more nervous in controlling the temperature and tensile stress within suitable ranges.

As described above, the tension annealing method applied to magnetic wire with a diameter of less than 20 μm by controlling the temperature and tensile stress within the suitable ranges to improve both magnetic properties and productivity has met complicated tradeoff problems among many factors such as variation of the wire diameter, wire elongation in the furnace, variation of the friction between the wire and the reels and change of the rotation speed of the reels and capstans, so that the complicated tradeoff problems cannot be solved easily.

### Means to Solve Technical Problems

The present invention provides a method to keep the temperature and tensile stress of the wire in the furnace at the designated values within suitable ranges. The tensile stress value calculated from the ratio of the wire tension to the wire diameter before inserting in the furnace measured precisely by a tension measuring device and a wire diameter measuring device respectively is controlled to be equivalent to the designated value by controlling the conveyance speeds and tensions at intervals between capstans using the capstans and tension rollers set at intervals between capstans. The wire temperature dependent on the wire holding time in the furnace is controlled to be equivalent to the designated value by controlling the conveyance speed of the wire in the furnace in consideration of the furnace length and the wire diameter.

The wire temperature requires strict control because higher temperature is desirable to reduce the anisotropy field and to allow the conveyance speed to be faster but a temperature higher than critical temperature, for example 550° C., causes a remarkable increase of the anisotropy field. Wire temperature in the furnace is decided by designated temperature in the furnace, the wire diameter and the holding time in the furnace. The holding time in the furnace is decided by the furnace length and the conveyance speed. The furnace length as short as possible is desirable in consideration of the cost and size of the furnace. If the conveyance speed is faster, the difference between the wire temperatures at the entrance of the furnace, the center, and the exit becomes larger and causes difficulties to keep designated temperature. Therefore, the conveyance speed is adjusted to hold the wire temperature equal to the designated temperature in the furnace in consideration of the wire temperature, the wire diameter, the conveyance speed and the length of the furnace.

The tensile stress calculated by the load tension and wire diameter needs rigorous management considering the synergistic effect of the temperature and the tensile stress. As the tensile stress within the elastic limit of the wire alloy becomes bigger, the hysteresis becomes smaller, while the critical temperature of the amorphous wire for tension annealing is dependent on the tensile stress value and change of the wire elongation in the furnace and it is lowered below 550 degrees C. by a larger tensile stress. Therefore, tension measurement equipment is installed just before the furnace entrance to measure the tension of the wire in the furnace with high accuracy. The tensile stress measured continuously by the tension measuring device is controlled to be equivalent to the designated value by the conveyance speed forced by the capstans and the tension loaded by the tension rollers

In the case of a glass coated amorphous wire, both diameters of the whole wire with glass and the metal part are measured for calculation of the tensile stress value of the alloy part using the load tension of the whole wire which is adopted as the tensile stress value of tension annealing.

The present invention also provides a method to achieve continuous long time production with a fast conveyance speed. The furnace of this invention becomes longer in length between a supply bobbin and a wind-up bobbin because it equips a wire diameter measuring device and tension measuring device and the wire used is smaller than 30 μm in diameter, so that the wire loaded is apt to make break down.

Solving the problem, the interval between a supply bobbin and a wind-up bobbin is divided to several parts which have one capstan each to control the conveyance speed and one tension roller to control the tension at the part respectively. The deference among the parts in the conveyance speed and the tension are dissolved by adjusting them to be equal using the capstans and the tension rollers. As a result, wire breakage is prevented and continuous operation at a fast conveyance speed is achieved by keeping uniform tension and conveyance speed at each part.

This invention has the advantage of producing a magnetic wire with excellent magnetic properties by controlling the temperature and tensile stress to the designated values in a tension annealing furnace by means of a wire diameter measuring device, a tension measuring device, several capstans and tension rollers installed at each of several divided parts between the supply bobbin and the wind-up bobbin. It has the advantage of achieving long time continuous operation without wire breakage and high productivity.

### BRIEF DESCRIPTION OF DRAWINGS

FIG. 1 is a schematic view of a tension annealing furnace for a magnetic wire.

FIG. 2 shows effects of tension annealing temperature on a magnetic property of magnetic wire.

### DETAILED DESCRIPTION OF EMBODIMENTS

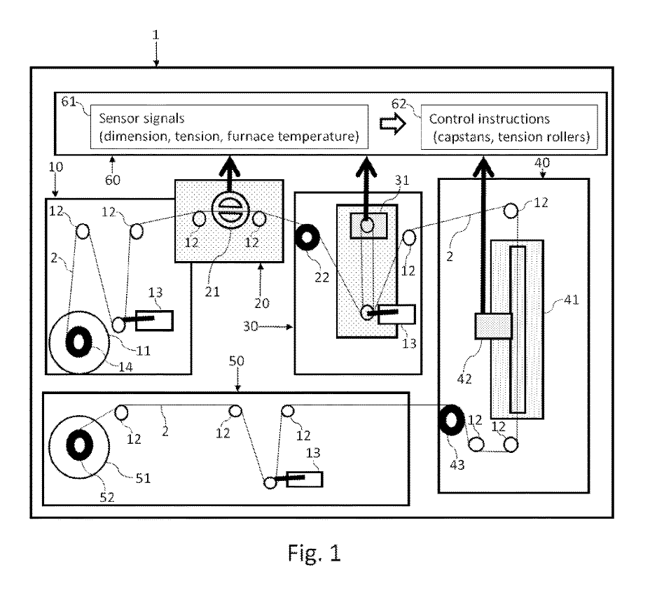

Preferred embodiments depend on objects for the work and performance requested from applications. The first embodiment of the present invention on the structure of a tension annealing furnace for a magnetic wire is explained as below using FIG. 1. The tension annealing furnace 1 for a magnetic wire consists of 6 parts of a wire supply part 10, a wire diameter measurement part 20, a wire tension measurement part 30, a tension annealing furnace 40, a wire winding up part 50, and a control unit 60. The wire supply part 10 comprises a supply bobbin 11, wire reels 12, a tension roller 13, and a supply capstan 14. The wire diameter measurement part 20 comprises a wire diameter measuring device 21, a post diameter measurement capstan 22, and wire reel 12. The wire tension measurement part 30 comprises a tension measuring device 31, wire reels 12, and a tension roller 13. The tension annealing furnace 40 comprises a tension annealing furnace 41, a temperature measuring device 42, a post heat treatment capstan 43, and wire reels 12. The wire winding up part 50 comprises a wind-up bobbin 51, a winding up capstan 52, wire reels 12, and a tension roller 13. The control unit 60 is equipped with a receiver 61 for sensor signals indicating such values as diameter, tension, temperature, and rolling speed and control instructions 62 for the capstans, tension rollers, the heater of the furnace to control the designated temperature and tensile stress of the wire.

The control unit 60 has an input unit 61 to receive related sensor signals as the wire dimeter, wire tension, furnace temperature, wire conveyance speed of each capstan 14, 22, 43, and 52, and the tension value of each tension roller 13 and also has control instructions 62 to keep the temperature and the tensile stress at the designated values by controlling the wire conveyance speed given by each capstan 14, 22, 43, and 52 and the tension adjusted by each tension roller 13 operated based on the value calculated from the related sensor signals.

The first embodiment is operated in series of procedures as bellow. The magnetic wire 2 wound on a supply bobbin 11 is drawn from the wire supply part 10 to the wire diameter measurement part 20 where the wire diameter is measured by the wire diameter measuring device 21. Subsequently it is carried to the wire tension measurement part 30, where the tension is measured precisely by the tension measuring device 31 and the conveyance speed and tensile stress are adjusted to the designated values respectively with tension roller 13 and the post diameter measurement capstan 22. The wire is tension annealed in the tension annealing furnace 40 at the designated values of temperature and tensile stress respectively and is carried out to the wire winding up part 50 where it is wound on a wind-up bobbin through adjusting the wire conveyance speed to the designated value by using the post heat treatment capstan 43, winding up capstan 52 and a tension roller 13.

As for the magnetic wire 2, a glass coated amorphous wire with a diameter from 10 μm to 30 μm is used. The wire of 1 km to 5 km is wound on the supply bobbin 11 with an inner diameter of 30 mm and with a flange. Each wire reel 12 is a V-groove roller type. Tension roller 13 can adjust the load from 1 g to 20 g with the accuracy of 0.1 g. In the case of a wire diameter of 10 μm, the tension roller can control the tensile stress of from 100 MPa to 2000 MPa with accuracy of 10 MPa. Each capstan, 14, 22, 43, and 52 can control the wire conveyance speed from 1 m to 1000 m per minute by controlling the rotary speed. The tension annealing furnace is a vertical structure type free from bending stress with a furnace length of from 10 cm to 100 cm.

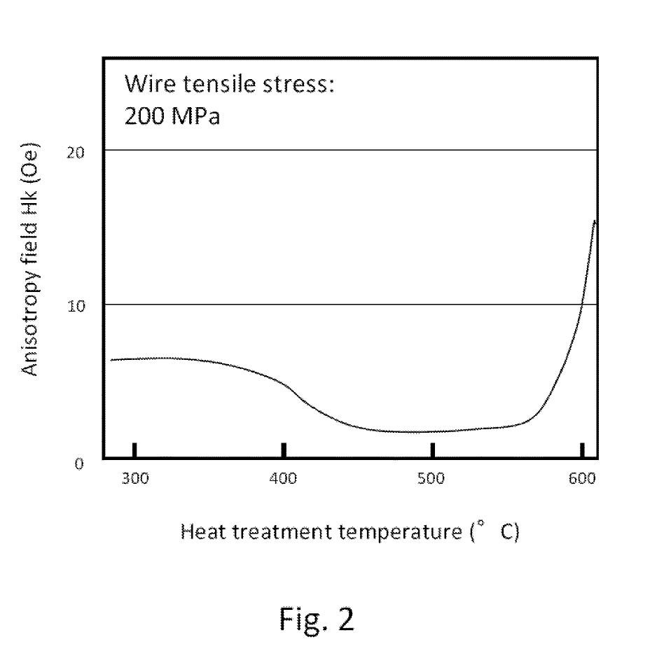

The temperature of the tension annealing furnace, as shown in FIG. 2, gives the most important influence on the magnetic properties and the optimal temperature range is from 450° C. to 550° C. The optimal temperature range is dependent on the alloy composition of the magnetic wire 2. In the case of amorphous alloy, the magnetic property falls extremely at the crystallization temperature around 550° C. or higher. The nearer 550° C. temperature setting of the furnace 41 is desirable to get better magnetic properties and a faster conveyance speed. But the crystallization temperature of amorphous wire 2 in the furnace varies from 550° C. to lower temperature according to the variation of the tensile stress, wire diameter, and conveyance speed. It is careful the furnace setting temperature becomes over the crystallization temperature of the amorphous alloy. Therefore, keeping tensile stress and conveyance speed controlled to designated values, the temperature is brought as close to 550° C. as possible.

The wire tensile stress is an important factor in the tension annealing method. A larger tensile stress of the magnetic wire 2 in the furnace can make more reduction in the hysteresis of the magnetic wire and more increase in the anisotropy field at temperature of near 550° C. Too big a tension load causes a strong frictional force between the rollers and the wire resulting in wire breakage. Therefore, it is very important to control the tension of the wire to a designated value. The value of the wire tension in the furnace is calculated by the tension measured by the tension measuring device 31 and the wire diameter measured by the wire diameter measuring device 21. Its value is controlled to be equal to the designated value with adjusting tension and conveyance speed using the tension roller 13 placed upstream of the furnace and the post heat treatment capstan 43.

The wire diameter measuring device 21 is produced based on some physical principles such as a laser type size measuring device, a size measuring device with magnetic impedance, and a microscope size measuring device and it can measure diameter of from 10 μm to 30 μm with accuracy of 0.5 μm. The tension measuring device 31 is produced using a strain gage type to achieve high accuracy and it can measure a tensile stress of from 0 to 2000 MPa with accuracy of 1 MPa.

The furnace 1 has two difficult problems compared to the conventional one. The first problem is to have a longer interval between the supply bobbin 11 and the wind-up bobbin 51 than the current one because the wire diameter measuring device 21 and the tension measuring device 31 are installed. The problem is solved by dividing the long interval to four parts which are the wire supply part 10, the measuring parts 20, 30, the furnace 40 and the winding up part 50. The wire in the four parts is carried with suitable speed by each capstan placed in each part. The second problem is that the tension and speed at each part controlled by the capstan and tension roller placed are different from each other. The deference causes variation in wire conveyance speed and friction between the tension rollers and the wire to result in wire breakage. The problem is solved by the control unit which can calculate the deference of the tension and wire conveyance speed continuously and control each tension using each tension roller and each speed using each capstan at high speed of from 1 m to 10 m per minute.

The second embodiment of this invention applied to a wire covered with insulating material 2 is the first one further which is equipped with a type of a wire diameter measuring device to measure the inner diameter of the metal portion and the outer diameter of the wire covered with insulating material. The tensile stress is calculated from the net tension only loaded to the wire metal part which is divided by the metal diameter

The third embodiment is directed to a preferred method of tension annealing the magnetic wire 2 using the first embodiment or the second embodiment. This method requests to measure the diameter, the tensile stress, the temperature and the conveyance speed using the wire diameter measuring device 21, the tension measuring device 31, the temperature measuring device 42, and the capstans 14, 22, 43, 52 respectively and to perform tension annealing within the temperature of from 450° C. to 550° C., the tensile stress of from 50 MPa to 250 MPa and the conveyance speed of from 1 m to 10 m per minute in the furnace. This method is implemented as a program of the control unit 60.

### EXAMPLES

The detail of the present invention is explained according to the preferred examples bellow.

### Example 1

The first example is explained as below based on FIG. 1 and FIG. 2. The tension annealing furnace 1 for a magnetic wire consists of six parts of a wire supply part 10, a wire diameter measurement part 20, a wire tension measurement part 30, a tension annealing furnace 40, a wire winding up part 50, and a control unit 60. The wire supply part 10 comprises a supply bobbin 11, wire reels 12, a tension roller 13, and a supply capstan 14. The wire diameter measurement part 20 comprises a wire diameter measuring device 21, a post diameter measurement capstan 22, and wire reels 12. The wire tension measurement part 30 comprises a tension measuring device 31, wire reels 12, and a tension roller 13. The tension annealing furnace 40 comprises a tension annealing furnace 41, a temperature measuring device 42, a post heat treatment capstan 43, and wire reels 12. The wire winding up part 50 comprises a wind-up bobbin 51, a winding up capstan 52, wire reels 12, and a tension roller 13. The control unit 60 is equipped with a receiver 61 for indicating such values such as diameter, tension, temperature, and rolling speed and control instructions 62 for the capstans, tension roller, the heater of the furnace to control the designated temperature and tensile stress of the wire.

The control unit 60 has an input unit 61 to receive related sensor signals of the wire dimeter, wire tension, furnace temperature, wire conveyance speed of each capstan 14, 22, 43, and 52, and the tension value of each tension roller 13 and also has control instructions 62 to keep the temperature and the tensile stress at the designated values by controlling the wire conveyance speed given by each capstan 14, 22, 43, and 52 and the tension adjusted by each tension roller 13 operated based on the value calculated from the related sensor signals.

The first embodiment is operated in series of procedures as bellow. The magnetic wire 2 wound on a supply bobbin 11 is drawn from the wire supply part 10 to a wire diameter measurement part 20 where wire diameter is measured by the wire diameter measuring device 21. Subsequently it is carried to the wire tension measurement part 30 where the tension is measured precisely by the tension measuring device 31 and the conveyance speed and the tensile stress are adjusted to the designated values respectively with the tension roller 13 and the post diameter measurement capstan 22. The wire is tension annealed in the tension annealing furnace 40 at the designated values of temperature and tensile stress respectively and is carried to the wire winding up part 50 where it is wound on a wind-up bobbin through adjusting the wire conveyance speed to the designated value by using the post heat treatment capstan 43, winding up capstan 52 and the tension rollers 12.

As for the magnetic wire 2, a glass coated amorphous wire with a diameter of 10 μm is used. The wire of 1 km is wound on the supply bobbin 11 with an inner diameter of 30 mm and with a flange. Wire reel 12 is a V-groove roller type. Tension rollers 13 load weight of 2 g (200 Mpa) with the accuracy of 0.1 g (10 Mpa) to the wire. Each capstan, 14, 22, 43, and 52 control wire conveyance speed of 1 m per minute by the rotary speed of 10 rpm with accuracy of 0.01 rpm under operation. The tension annealing furnace is a vertical structure type free from bending stress with the furnace length of 30 cm.

The temperature of the tension annealing furnace, as shown in FIG. 2, gives the most important influence on the magnetic properties. The temperature is set to 530° C. which is 20° C. bellow the crystallization temperature of the amorphous alloy. If the wire temperature exceeds 550° C., the magnetic properties become poor remarkably. It is important to keep the temperature below 550° C. The conveyance speed is 1 m per minute and the holding time in the furnace is 18 seconds. The net length of the wire heated up to the designated temperature of 530° C. is reduced as much as possible with a result that the elongation and the change of tensile stress of the wire become small.

A large tensile stress of the wire in tension annealing treatment can reduce hysteresis of the wire but increase the anisotropy field. The tension annealing is carried out at a designated tensile stress of 200 MPa and designated temperature of 530° C. and results in magnetic properties such as a coercive force of 0.01 Oe and an anisotropy field of 1 Oe wherein smaller coercive means smaller hysteresis. The continuous operation of 1 km wire can be carried out without wire breakage when the values of tension and conveyance speed are controlled to be equal to the designated values with adjusting tension and conveyance speed using the tension roller 13 placed upstream of the furnace and the post heat treatment capstan 43. The value during operation is calculated by the tension measured by the tension measuring device 31 and the wire diameter measured by the wire diameter measuring device 21.

A size measuring device 21 with magnetic impedance are used to measure diameter of from 10 μm with accuracy of 0.5 μm. The strain gage type of tension measuring device 31 is used to measure and control a tensile stress of 2000 MPa with accuracy of 1 MPa. The measured values are input in the control unit where they are recorded corresponding to the designated distance from the start of wire drawing and the designated distance inserted into the furnace is treated at the time with the temperature of 530° C. and tensile stress of 200 MPa.

The interval between the supply bobbin 11 and the wind-up bobbin 51 becomes as long as 4 m because the wire diameter measuring device 21 and the tension measuring device 31 are installed. The problem is solved by dividing the long interval into four parts consisting of the wire supply part 10, the measuring parts 20, 30, the furnace 40 and the winding up part 50 which have each a capstan 14, 22, 43, 52 and a tension roller 13 between capstans. By controlling the tension and speed at each part controlled by the capstan and tension roller placed, the differences in wire conveyance speed and the friction between tension roller and wire are dissolved and continuous operation of 1 Km at the speed of 1 m per minute can be performed without wire breakage.

As shown above in the present example, the magnetic properties of the magnetic wire is improved from 5 Oe to 1 Oe in the anisotropy field, and from 0.1 Oe to 0.01 Oe in coercive force by operating with a magnetic wire temperature of 530° C., a tensile stress of 200 MPa and a conveyance speed of 1 m per minute. Therefore, the magnetic sensitivity of GSR sensor strongly dependent on the magnetic properties of the amorphous wire is improved largely and it can be developed into a lot of applications.

### Example 2

The second example of the present invention applied to a glass coated amorphous wire 2 with an inner metal diameter of 10 μm and an outer diameter of 12 μm including coated glass is the first example further which is equipped with a type of a wire diameter measuring device to measure the inner diameter of the metal part and the outer diameter of the wire covered with insulating material. The tensile stress is calculated from the net tension only loaded to the wire metal part which is divided by metal diameter.

### Example 3

The third example is related to a method carried out using the furnace described in the first example. This method requests to measure the diameter, the tensile stress, the temperature and the conveyance speed using the wire diameter measuring device 21, the tension measuring device 31, the temperature measuring device 42, and the capstans 14,22, 43, 52 respectively and to perform tension annealing within the temperature range of from 450° C. to 500° C., the tensile stress of from 50 MPa to 250 MPa and the conveyance speed of from 1 m to 10 m per minute in the furnace. This method is implemented as a program of the control unit 60.

### INDUSTRIAL APPLICABILITY

As mentioned above, the present invention directed to a tension annealing furnace and a method therefor is useful in improving the magnetic performance of GSR censor through improving the magnetic properties of magnetic wire.

### REFERENCE SIGNS LIST

1: a heat treatment equipment of magnetic wire

2: magnetic wire

10: wire supply part

11: supply bobbin

12: wire reel

13: tension roller

14: supply capstan

20: wire diameter measurement part

21: wire diameter measuring device

22: post diameter measurement capstan

30: wire tension measurement part

31: tension measuring device

40: tension annealing furnace

41: furnace for tension annealing treatment

42: temperature measuring device

43: capstan after heat treatment

50: wire winding up part

51: bobbin for winding up

52: winding up capstan

60: control unit

61: input unit of sensor signals (dimension, tension, furnace temperature)

62: control instructions (capstans, tension rollers)

What is claimed is:

1. A heat treatment apparatus to apply tension annealing to magnetic wire comprising:
a wire supply part comprising a supply bobbin on which magnetic wire is wound, wire reels, a capstan for supply, and a tension roller,
a wire diameter and wire tension measurement part comprising a wire diameter measuring device, a tension measuring device, a post measurement capstan, a tension roller and wire reels,
a tension annealing furnace comprising a furnace for heat treatment, a temperature measuring device, a post heat treatment capstan, a tension roller and wire reels,
a wire winding up part comprising a wind-up bobbin, a rolling up capstan, and wire reels,
a control unit comprising an input unit to receive signals given by the wire diameter measuring device, the tension measuring device, the temperature measuring device, and the plurality of capstans and tension rollers and control instructions controlling the temperature, the tensile stress of the wire and the conveyance speed in the furnace to designated values by adjusting said rotary speed of the capstans and the tensile tension of the tension roller placed between said supply bobbin and a said wind-up bobbin, to make measured values of the temperature, the tensile stress and the conveyance speed equal to the designated values respectively.

2. A heat treatment apparatus of claim 1 applied to an amorphous wire coated with an insulation material further comprising a wire diameter measuring devices to measure two diameters including an inner diameter of wire metal and an outer diameter of the magnetic wire including the insulation material on its surface.

3. A heat treatment method using the heat treatment apparatus of claim 1 to apply a tension annealing to magnetic wire within a temperature range of from 450° C. to 550° C., a tensile stress of from 50 MPa to 250 MPa and a conveyance speed of from 1 m to 10 m per minute in the furnace controlled by the measured values of diameter, tensile stress, temperature, and conveyance speed with arranged measuring instruments installed into a process in which the magnetic wire is supplied from the supply bobbin on which the wire is wound, then carried through the wire measurement part and the wire tension measurement part, subsequently inserted into the tension annealing furnace, and finally wound on the bobbin equipped with a capstan to control a rotary speed by using the capstans, the tension rollers and the wire reels.

4. A heat treatment method using the heat treatment apparatus of claim 2 to apply a tension annealing to magnetic wire within a temperature range of from 450° C. to 550° C., a tensile stress of from 50 MPa to 250 MPa and a conveyance speed of from 1 m to 10 m per minute in the furnace controlled by the measured values of diameter, tensile stress, temperature, and conveyance speed with arranged measuring instruments installed into a process in which the magnetic wire is supplied from the supply bobbin on which the wire is wound, then carried through the wire measurement part and the wire tension measurement part, subsequently inserted into the tension annealing furnace, and finally wound on the bobbin equipped with a capstan to control a rotary speed by using the capstans, the tension rollers and the wire reels.
